(19) United States
(12) Patent Application Publication
(10) Pub. No.: US 2003/0098847 A1
(43) Pub. Date: May 29, 2003

(54) Information display apparatus

(76) Inventor: Yuji Yamamoto, Saitama (JP)

Correspondence Address: ROBIN BLECKER & DALEY, 2ND FLOOR, 330 MADISON AVENUE, NEW YORK, NY, 10017, US

(21) Appl. No.: 10/298,843

(22) Filed: Nov. 18, 2002

(30) Foreign Application Priority Data
Nov. 27, 2001 (JP) 361073/2001

(51) Int. Cl. G09G 5/00

(52) U.S. Cl. 345/158

(57) ABSTRACT

This specification discloses an information display apparatus comprising a display member for displaying information, operating means having operation parts disposed at at least four upper, lower, left and right locations, control means for effecting predetermined control by the operation parts being operated, position detecting means for detecting the position state of the apparatus, display changing means for rotating the display displayed on the display member and changing the position of the display in conformity with the result of the detection by the position detecting means, and operation part changing means for changing the operated location of the operation parts which effect the control in conformity with the result of the detection by the position detecting means.

### BACKGROUND OF THE INVENTION

1. Field of the Invention

This invention relates to an information display apparatus having at least display means for displaying information and a cross direction operation key for effecting selection conforming to the display by the display means.

2. Related Background Art

There is known an apparatus having information displaying means, in an apparatus such as a camera or a cellular phone, and a so-called cross key having operation parts at four upper, lower, left and right locations, and for effecting predetermined control conforming to the operation positions of the operation parts of the cross key, for example, the selection and decision of a photographing mode, or control conforming to display substance displayed on a display apparatus.

In the above-described example of the prior art, however, no mention is made of the differences in the position of the apparatus, and for example, photographing by a camera includes various photographing scenes such as levelling the camera in a vertical position, and the position of the camera is not always a normal position (horizontal position). Accordingly, for example, in the case of a vertical position in which the camera has been rotated by 90 degrees from its normal position, displayed information is displayed sideways to the photographer and therefore it becomes very difficult to read it.

Further, even when the display changes in conformity with the difference in the position, if the direction of operation of the cross key is also changed in conformity with the difference in the position, the operability will become bad.

### SUMMARY OF THE INVENTION

In view of the above-noted problem, it is a first object of the present invention to provide an information display apparatus in which the direction of display is changed in conformity with the position of the apparatus and the operation position of a cross key is also changed in accordance with a change in the direction of display, whereby even if the position of the apparatus is changed, a photographer can obtain similar operating feelings before and after the change of the position.

It is a second object of the present invention not to change the direction of display of a replay image even if in the first object, the direction of display of photographing information or the like and the operability of the cross key are changed by the difference in the position, because if in the first object, the replay image is also changed in conformity with the position like display data, the photographer cannot see the replay image in a direction in which he wants to see.

In order to achieve the first object, the present invention provides the information display apparatus with displaying means (11, 16) for displaying information, operating means (cross key) having operation parts disposed at at least four upper, lower, left and right locations, control means (system control part) for effecting predetermined control by the operation parts being operated, position detecting means (10, 13) for detecting the position state of the apparatus, display changing means (system control part) for changing the direction of predetermined display displayed on the display means in conformity with the result of the detection by the position detecting means, and operation part changing means (system control part) for changing the operated locations of the operating parts for effecting the control in conformity with the result of the detection by the position detecting means.

Or the present invention provides the information display apparatus with display means for displaying information, operating means having operation parts disposed at at least four upper, lower, left and right locations, control means for effecting predetermined control by the operating parts being operated, position detecting means for detecting the position state of the apparatus, display changing means for rotating the display displayed on the display means in conformity with the result of the detection by the position detecting means and also changing the position of the display, and operation part changing means for changing the operated locations of the operation parts for effecting the aforementioned control in conformity with the result of the detection by the position detecting means.

Specifically, the aforementioned predetermined display is a plurality of displays indicative of the modes (image quality setting . . . modulated light correction, mail . . . cancel) of the apparatus, and the display changing means rotates the direction of arrangement of the row of characters or the display, and changes the position of the row of characters (or the position of the display, in conformity with the position.

Also, the aforementioned predetermined control is control for effecting display (reversal display) indicative of being selected, of a plurality of modes displayed.

Also, the aforementioned predetermined display is a display indicative of the substance of the operation of the operation parts (the termination and determination marks of FIGS. 7A and 7B of the accompanying drawings or the characters thereof, and marks indicative of the back and forward displays of FIGS. 11A and 11B of the accompanying drawings, or the characters thereof or the like), and the display changing means changes the direction and position of display of the substance of the operation.

Also, the aforementioned predetermined control is control conforming to the substance of the operation.

Also, the operation part changing means changes the operated location so that even if the position of the apparatus is changed, the substance of the control of the operation parts located vertically upward and downward or the operation parts located at horizontally left and right may not be changed.

Also, under the second object, the display means further displays a photographed image, but this image is not rotated and converted depending on the position.

### BRIEF DESCRIPTION OF THE DRAWINGS

FIG. 1 is a block diagram showing the construction of a camera according to an embodiment of the present invention.

FIG. 2 is a rear view of the camera according to the embodiment.

FIG. 3 is a flow chart of a system control part relating to the present invention.

FIG. 4 is a flow chart of the system control part relating to the present invention.

FIG. 5 is a flow chart of the system control part relating to the present invention.

FIG. 6 is a flow chart of the system control part relating to the present invention.

FIGS. 7A and 7B show the display state of the camera relating to the present invention.

FIG. 8 is a flow chart of the system control part relating to the present invention.

FIG. 9 is a flow chart of the system control part relating to the present invention.

FIG. 10 is a flow chart of the system control part relating to the present invention.

FIGS. 11A and 11B show the state of display of the camera relating to the present invention.

FIG. 12 is a block diagram showing an electrical construction relating to the present invention.

FIG. 13 is a front view of a telephone relating to the present invention.

FIG. 14 is a flow chart of the system control part relating to the present invention.

FIG. 15 is a flow chart of the system control part relating to the present invention.

FIG. 16 is a flow chart of the system control part relating to the present invention.

FIG. 17 is a flow chart of the system control part relating to the present invention.

FIGS. 18A and 18B show the state of the display by a telephone relating to the present invention.

### DESCRIPTION OF THE PREFERRED EMBODIMENTS

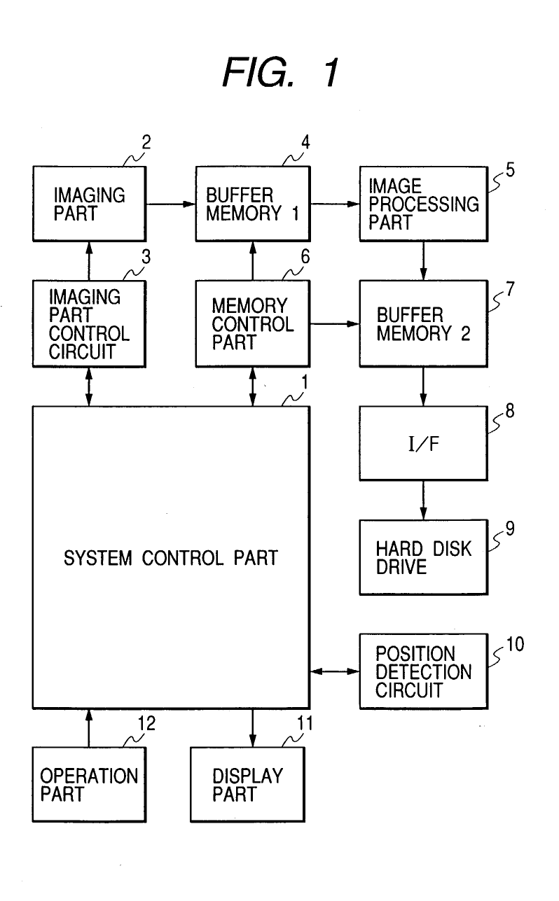

An embodiment of the present invention will hereinafter be described in detail with reference to FIGS. 1 to 7A and 7B. FIG. 1 is a block diagram schematically showing the construction of a camera according to the present invention.

In FIG. 1, the reference numeral 1 designates a central processing circuit (CPU) as a system control part which effects communications with an imaging part control circuit, a memory control part, a position difference detection circuit, a display part and an operation part which will be described later and effects the control of an entire system.

The reference numeral 2 denotes an imaging part which is a module group concerned in imaging including an optical system (lens), a stop and a solid state image pickup element such as a CCD (charge-coupled device) for forming an object image. The reference numeral 3 designates an imaging part control circuit which effects the control of the focal length of the lens, the stop, the driving of the CCD, etc. The reference numeral 4 denotes a front buffer memory which is a temporary storing area.

The reference numeral 5 designates an image processing part which carries out image processing on the basis of image data photographed by the imaging part 2 and the image information thereof. The reference numeral 7 denotes a rear buffer memory. The reference numeral 6 designates a memory control part which controls the front buffer memory 4, the rear buffer memory 7 and a hard disk 9. The reference numeral 8 denotes an interface (I/F) for causing the rear buffer memory to the hard disk 9 to store therein the image data after image processing. The hard disk 9 stores the image data therein.

The reference numeral 10 designates a position detection circuit for detecting the positions (normal position (horizontal position), vertical position, reversal to the horizontal position, and reversal to the vertical position) of the main body of a camera. The reference numeral 11 denotes a display part such as liquid crystal which effects the display of a replay image and the display of various setting items. The reference numeral 12 designates an operation part provided with operation buttons such as a menu button, a replay button and a cross key.

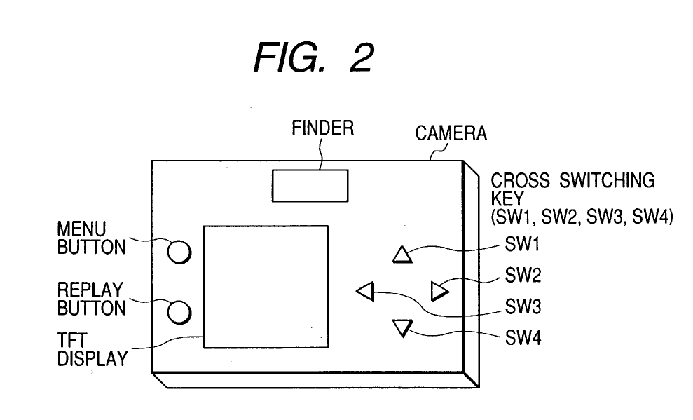

FIG. 2 is a view of the camera as it is seen from its back, and shows the arrangement of the operation buttons and displays used in the operation flows which will be described later.

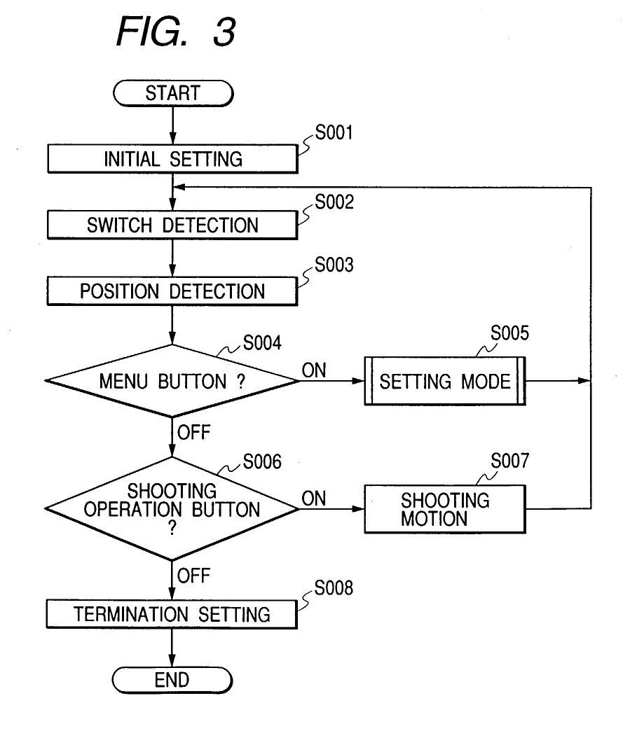

FIGS. 3 to 6 are flow charts representing the operation flow of the camera system control part 1, and this operation flow will hereinafter be described in detail.

At step S001 in FIG. 3, the camera effects initial setting such as the initialization of a register, the initialization of data and the initialization of the surrounding circuits. At S002, the detection of the states of the menu button, the replay button, the cross key, a photographing operation button, not shown, etc. is effected. At S003, the position difference of the camera is detected. If at S004, the menu button is ON, shift is made to S005, where shift is made to a setting mode for effecting various kinds of setting of the camera, and if the menu button is OFF, shift is made to S006.

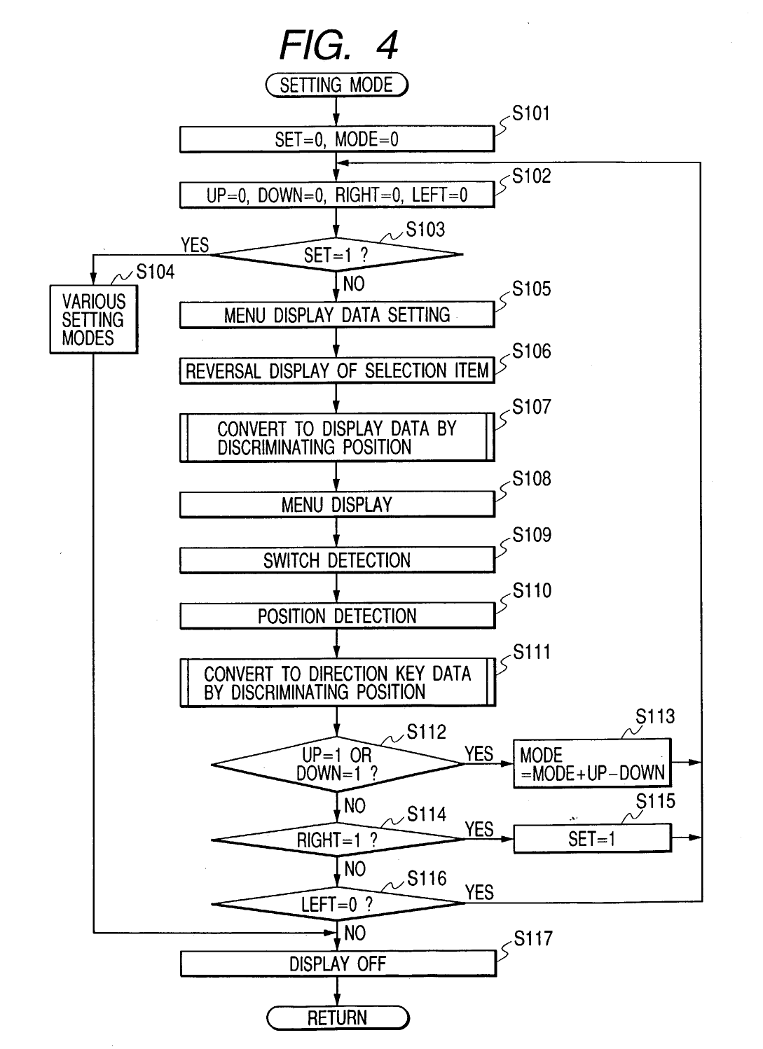

The operation in the setting mode will be described in detail here with reference to FIG. 4.

At step S101 in FIG. 4, a SET flag for discriminating a menu mode for selecting the setting items and various setting modes for actually effecting the setting and MODE data for discriminating the setting items are set to 0.

At S102, flags (UP, DOWN, LEFT and RIGHT) which can change the button state of the cross key in conformity with the position of the camera are set to 0. These flags discriminate the depressed states of respective buttons located upward, downward, leftward and rightward in a state in which the cross key is seen from the front when a photographer levels the camera, and the system control part sets the flags to “1” when the cross key is depressed.

If at S103, SET=1, it means the various setting modes and therefore, shift is made to S104, where the various kinds of setting of the camera are effected. Unless SET=1, shift is made to S105. At S105, a setting item and the data of menu display for selecting the item are generated.

At S106, from MODE data, the display data of the item being selected is made into the data of reversal display. By doing so, the item being selected is shown so as to be easily understood by the user.

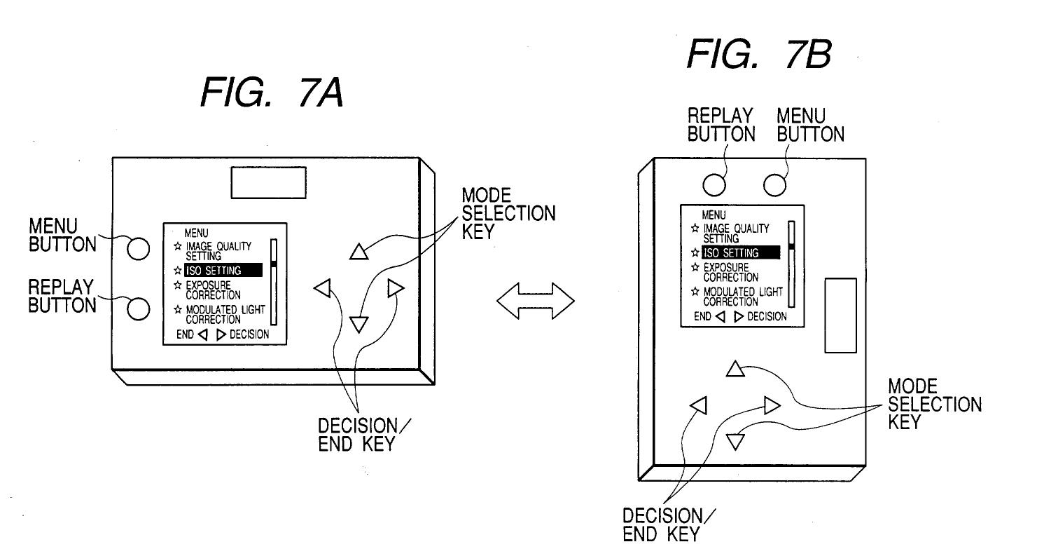

At S107, the state of the position is discriminated and the display data is converted. In the present embodiment, as shown, for example, in FIGS. 7A and 7B, rows of characters representing image quality setting, ISO (sensitivity) setting, exposure correction, modulated light correction and the shape of the cross key, and further the meaning of the operation of this cross key are displayed on the screen. The display state is changed in conformity with the position of the apparatus so that even if the position of the apparatus is changed, it can always be read or observed in the same state. Specifically, the direction of display (or the rotation of display) and the position are changed so as to provide a display easy to see.

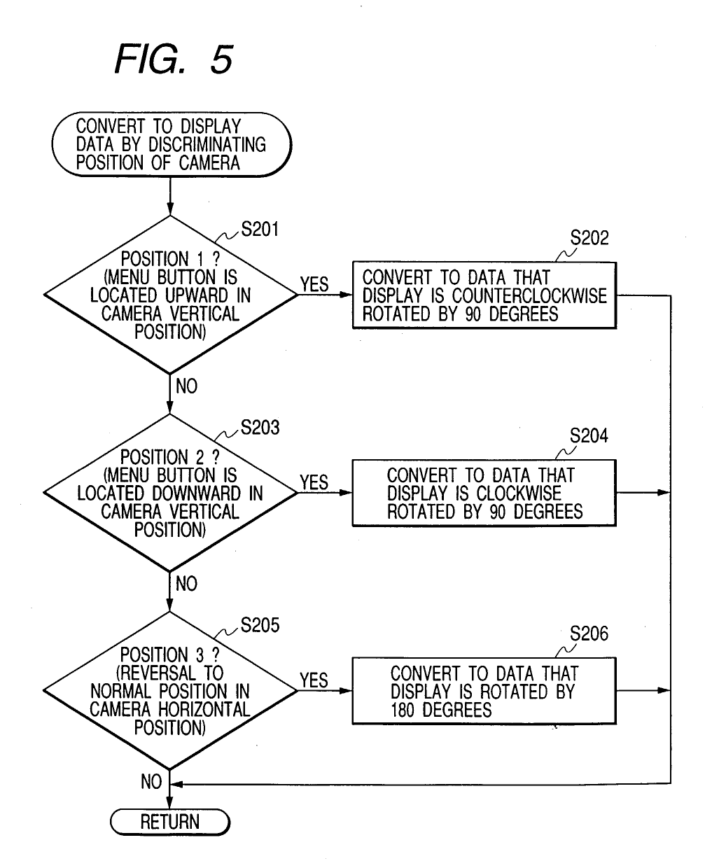

The operation flow of the conversion will be described here with reference to FIG. 5. If at S201 in FIG. 5, from the information obtained by the detection of the position, the position of the camera is position 1 (the camera is in a vertical position (that is, the menu button is in an upper state (FIG. 7B) and a state in which it is clockwise rotated by 90 degrees relative to the normal position of FIG. 7A), shift is made to S202, where the screen data generated at S105 and S106 is converted to data that display is counterclockwise rotated by 90 degrees. If the position of the camera is not position 1, shift is made to S203.

If at S203, the position of the camera is position 2 (the camera is in a vertical position, that is, the menu button is in a downward state (opposite to position 1) and a state in which it is counterclockwise rotated by 90 degrees relative to the normal position of FIG. 7A), shift is made to S204, where the screen data is converted to data that display is clockwise rotated by 90 degrees. If the position of the camera is not position 2, shift is made to S205. If at S205, the position of the camera is position 3 (the camera is in a horizontal position reversed by being rotated by 180 degrees relative to the normal position), shift is made to S206, where the screen data is converted to data that display is rotated by 180 degrees. If the position of the camera is not position 3, it is judged that the camera is levelled in the normal position, and return is made without the data being rotated and converted.

Turning back to the flow chart of FIG. 4, at S108 in FIG. 4, the screen data (menu display data) generated at S105, S106 and S107 are sent to the display part and are displayed thereby, and by doing so, irrespective of the position of the apparatus, display or characters in the same direction are displayed at all times.

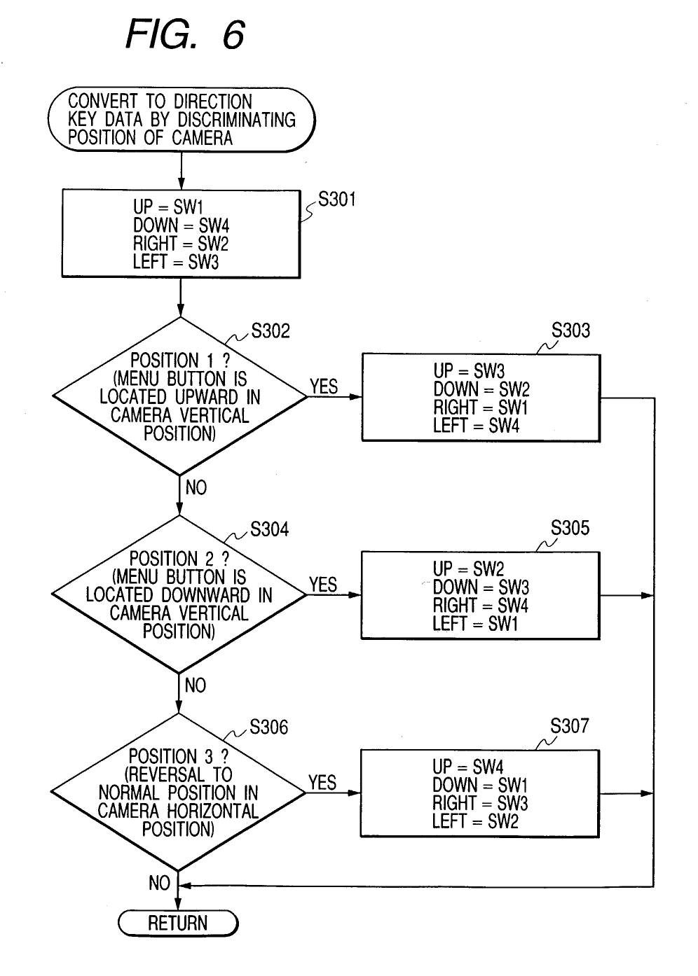

At S109, the detection of the states of the menu button, the replay button, the cross key, the photographing operation button, not shown, etc. is effected. At S110, the position state of the camera is detected. At S111, the position information obtained at S110 is discriminated and converted to direction key data. When no control as in the prior art is effected, the role and function of the operation switch (cross key) are not changed, but yet here, the role and function of the operation switch is changed by the position. When the position is changed from the normal position to a position in which the camera is rotated by 90 degrees, the role of a pair of operation switches located vertically upward and downward, for example, in the normal position (FIG. 7A) is changed to a pair of horizontal operation switches, whereby it becomes possible for the operator to operate with the same sense even if the position of the apparatus is changed. The converting operation will be described here with reference to FIG. 6.

At S301 in FIG. 6, the state data of the switch SW1 of the cross key is inputted to the UP flag, the state data of SW4 is inputted to the DOWN flag, the state data of SW2 is inputted to the RIGHT flag, and the state data of SW3 is inputted to the LEFT flag. The switches SW1, SW2, SW3 and SW4 are the upper, right, left and lower switches, respectively, when the camera is levelled in the normal position as shown in FIG. 2.

Now, if at S302, the position of the camera is the aforedescribed position 1, shift is made to S303, and if not so, shift is made to S304. At S303, the state data of SW3 is inputted to the UP flag, the state data of SW2 is inputted to the DOWN flag, the state data of SW1 is inputted to the RIGHT flag, and the state data of SW4 is inputted to the LEFT flag. By doing so, the role and function, for example, of the switch located vertically upward are not changed even if the position is changed.

If at S304, the position of the camera is position 2, shift is made to S305, and if not so, shift is made to S306. At S305, the state data of SW2 is inputted to the UP flag, the state data of SW3 is inputted to the DOWN flag, the state data of SW4 is inputted to the RIGHT flag, and the state data of SW1 is inputted to the LEFT flag.

If at S306, the position of the camera is position 3, shift is made to S307, and if not so, return is made. At S307, the state data of SW4 is inputted to the UP flag, the state data of SW1 is inputted to the DOWN flag, the state data of SW3 is inputted to the RIGHT flag, and the state data of SW2 is inputted to the LEFT flag.

As described above, the operated state of the cross key which is the operation switch is changed over to the UP flag and DOWN flag which prescribe a pair of vertically upward and downward positions and to the LEFT flag and the RIGHT flag which prescribe a pair of horizontally left and right positions. By doing so, even if the position is changed, it never happens that the role and function of the pair of vertically upward and downward operation switches or the pair of horizontally left and right operation switches are changed.

Turning back to FIG. 4, if at S112 in FIG. 4, UP=1 (this indicates a state in which the vertically upward switch is operated) or DOWN=1 (this indicates a state in which the vertically downward switch is operated), shift is made to S113, and if not so, shift is made to S114. At S113, the calculation of MODE=MODE+UP−DOWN is effected, and the up/down of the selection item is effected, and return is made to S102. That is, at S113, the states of the switches located vertically upward and downward are detected, and when for example, the upward switch is operated, the display state of the menu indicative of being selected is upped by one, and when the downward switch is operated, the display state of the menu indicative of being selected is downed by one.

If at S114, RIGHT=1 (this indicates that the horizontally right switch is operated), shift is made to S115, and if not so, shift is made to S116. The right switch at S115, as shown in FIGS. 7A and 7B, is set, in the case of the present embodiment, to SET=1 in order to effect the setting of the selected setting item (the decision of the item), and shift is made to S102.

Unless at S116, LEFT=0 (this indicates that the horizontal left switch is not operated), shift is made to S102, and if not so, shift is made to S117, and the display is turned off and return is made. As shown in FIGS. 7A and 7B, the left switch in the present embodiment is for instructing menu display to be terminated.

Turning back to FIG. 3, if at S006 in FIG. 3, the photographing operation button is ON, shift is made to S007, and if not so, shift is made to S008. At S007, the photographing operation including the distance measuring operation for photographing, the driving of the stop, the accumulating operation of the CCD, the reading-out of the CCD, image processing, image reading, etc. is performed and shift is made to S002. In order to terminate the operation of the camera at S008, the instructions for switching off the supply of electric power to the surrounding circuits and the termination setting such as the retraction of the data are effected, and the operation is terminated.

What has been described above is the operation flow of the system control part, and even if by the above-described operation, as shown in FIGS. 7A and 7B, the position of the camera is changed from that of FIG. 7A to that of FIG. 7B, the display by the camera is changed over by the position difference, and it also becomes possible for the role of the cross key to be likewise changed over by the position. Accordingly, before and after the position of the apparatus is changed, the operator can perform the observation of display and the operation of item selection with the same operation sense.

In the above-described embodiment, description has been made of the changeover of the display of menu selection. Description will now be made of the operation when the replay of the photographed and stored image is effected.

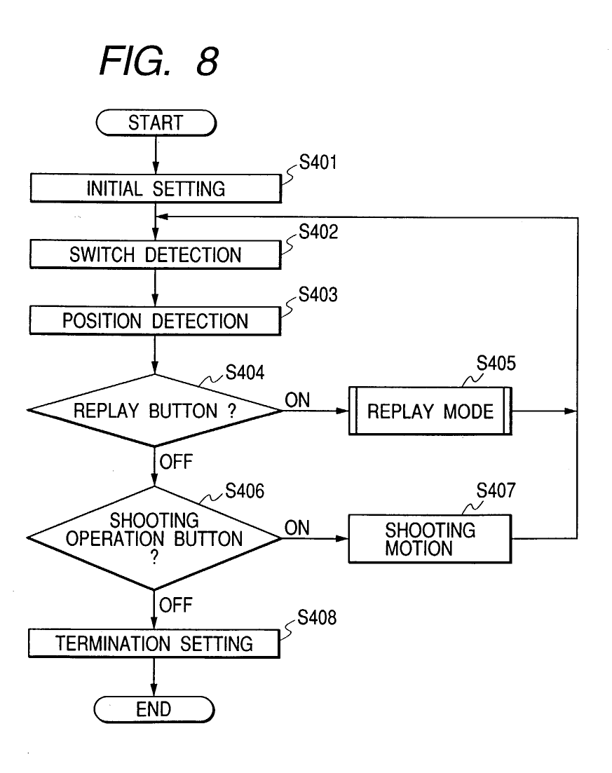

At S401 in FIG. 8, the camera performs initial setting including the initialization of the register, the initialization of data and the initialization of the surrounding circuits. At S402, the detection of the states of the menu button, the replay button, the cross key, the photographing operation button, not shown, etc. is effected. At S403, the position state of the camera is detected. If at S404, the replay button is ON, shift is made to S405 and shift is made to the replay mode for replaying the image, and if the replay button is OFF, shift is made to S406.

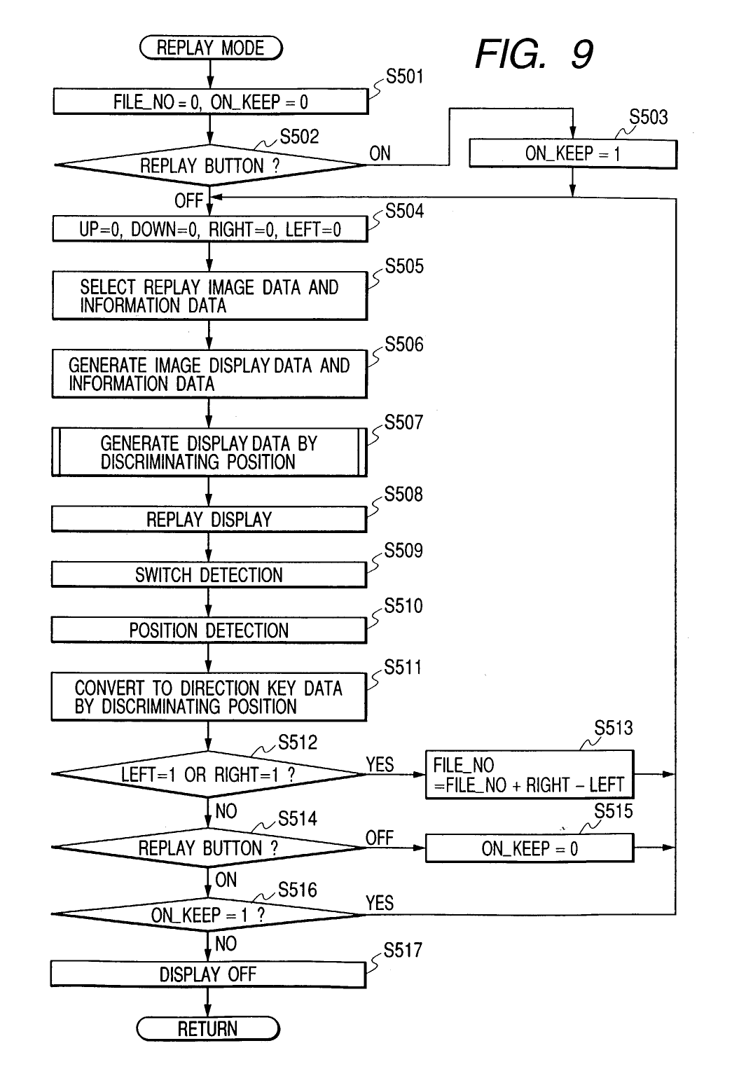

The operation in the replay mode will be described in detail here with reference to FIG. 9. At S501 in FIG. 9, 0 is set in FILE_NO which is number data for selecting the replay image and ON_KEEP flag for discriminating the re-depression of the replay button.

If at S502, the replay button is ON, shift is made to S503, and if not so, shift is made to S504. At S503, 1 is set in ON_KEEP flag indicating that the replay button remains ON. At S504, the flags (UP, DOWN, RIGHT and LEFT) capable of changing the button state of the cross key in conformity with the position are set to 0.

At S505, from the information of a hard disk (such as folder information) and the data of FILE_NO, replay image data is extracted out of the hard disk and further, the information data of the replay image data is extracted. The information data, in the present embodiment, refers to the data of the shutter speed and aperture information when photographing is effected and further, the display indicative of the role of the operation of the operation part of the cross key. Besides, this information data may be the date data during photographing or other necessary information.

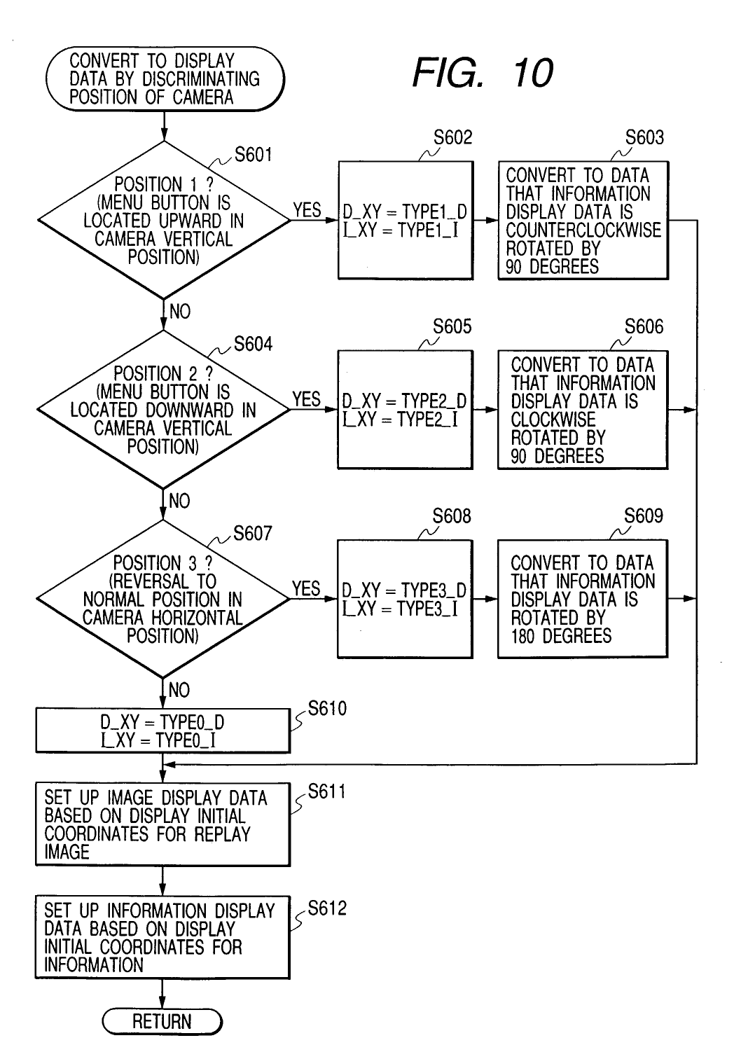

At S506, image display data is generated from the replay image data and information display data is generated from the information data. At S507, the position state is discriminated and display data is generated. The operation flow will be described here with reference to FIG. 10.

If at S601 in FIG. 10, from the position information, the position of the camera is the same position 1 as that described previously, shift is made to S602, and if not so, shift is made to S604.

At S602, display starting position data (TYPE1_D) for the replay image of position 1 is inputted to coordinates (D_XY) indicative of the display starting position for the replay image, and display starting position data (TYPE1_I) for the information of position 1 is inputted to coordinates (I_XY) indicative of the display starting position for information. At S603, the information display data is converted to data that display is counterclockwise rotated by 90 degrees from the display direction in the usual normal position (the character display direction in the normal position of the camera).

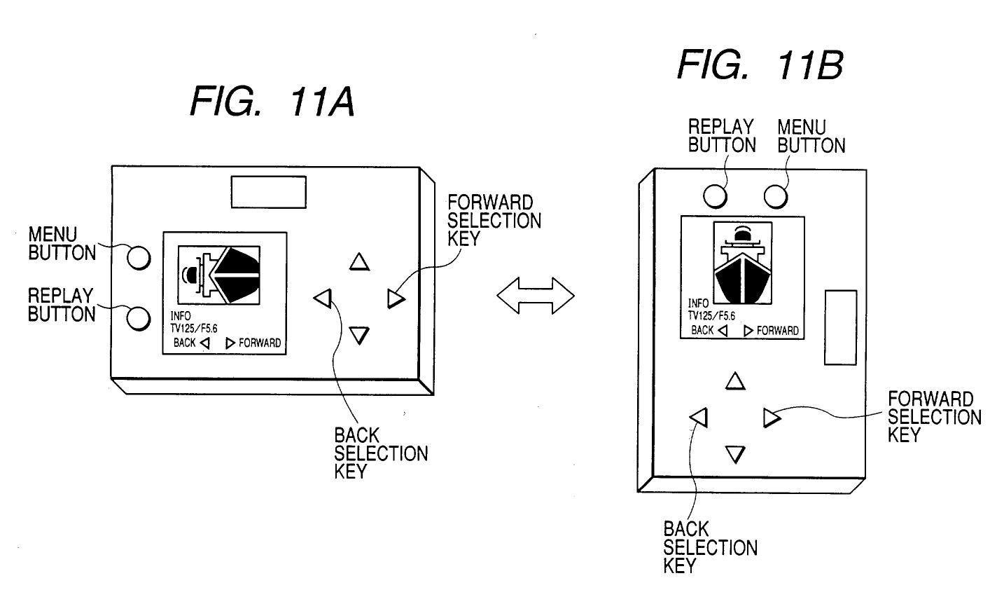

In the present embodiment, design is made such that the change of the starting position and rotation conversion are effected relative to the information display data and that regarding the replay image (video) data, rotation conversion is not effected. Only the display starting position is changed. By doing so, regarding the operation, the operating feeling does not change before and after the change of the position, but yet the replay image can be appreciated from any direction (see FIGS. 11A and

If at S604, the position of the camera is position 2, shift is made to S605, and if not so, shift is made to S607. At S605, display starting position data (TYPE2_D) for the replay image of position 2 is inputted to coordinates (D_XY) indicative of the display starting position for the replay image, and display starting position data (TYPE2_I) for the information of position 2 is inputted to coordinates (I_XY) indicative of the display starting position for the information. At S606, the information display data is converted to data that display is clockwise rotated by 90 degrees from the usual display direction (the character display direction in the normal position of the camera).

If at S607, the position of the camera is position 3, shift is made to S608, and if not so, shift is made to S610. At S608, display starting position data (TYPE3_D) for the replay image of position 3 is inputted to coordinates (D_XY) indicative of the display starting position for the replay image, and display starting position data (TYPE3_I) for the information of position 3 is inputted to coordinates (I_XY) indicative of the display starting position for the information. At S609, the information display data is converted to data that display is rotated by 180 degrees from the usual display direction (the character display direction in the normal position of the camera).

At S610, the camera is in the usual normal position and therefore, display starting position data (TYPE0_D) for the replay image of the normal position of the camera is inputted to coordinates (D_XY) indicative of the display starting position for the replay image, and display starting position data (TYPE0_I) for the information of the normal position of the camera is inputted to coordinates (I_XY) indicative of the display starting position for the information.

At S611, image display data for displaying an image is set from the display initial coordinates (D_XY) for the replay image into a memory for display. At S612, the information display data is set from the display initial coordinates (I_XY) for the information into the memory for display, and return is made.

Turning back to FIG. 9, at S508 in FIG. 9, the display data in the memory for display set by S507 is sent to and displayed on the display part. As previously described, the rotation of the replay image is not done, but only the information display data is rotated and displayed. At S509, the detection of the states of the menu button, the replay button, the cross key, the photographing operation button, not shown, etc. is effected.

At S510, the position state of the camera is detected. At S511, the position difference information obtained at S510 is discriminated and converted to direction key data. The substance of this conversion is the same as the flow shown in FIG. 6 and therefore need not be described.

If at S512, LEFT=1 (this indicates a state in which the horizontal left switch has been operated) or RIGHT=1 (this indicates a state in which the horizontal right switch has been operated), shift is made to S513, and if not so, shift is made to S514. At S513, FILE_NO=FILE_NO+RIGHT−LEFT is effected and the calculation of the selection number of the replay image is effected, and shift is made to S504.

By this calculation, such selection as selecting the preceding image or the succeeding image as the replay image by the operation key becomes possible.

If at S514, the replay button is OFF, shift is made to S515, and if not so, shift is made to S516. At S515, ON_KEEP flag is set to 0, and shift is made to S504.

If at S516, ON_KEEP=1, the replay button remains depressed and therefore, shift is made to S504. Unless ON_KEEP=1, shift is made to S517. That is, it is judged that the replay button is re-depressed, and in the present embodiment, the re-depression of the replay button in the replay mode means the release of the replay mode and therefore, at S517, the display is turned off and return is made.

Turning back to FIG. 8, if at S406 in FIG. 8, the photographing operation button is ON, shift is made to S407, and if not so, shift is made to S408. At S407, the photographing operations such as the distance measuring operation for photographing, the driving of the stop, the CCD accumulating operation, the reading-out of the CCD, image processing and image writing are performed, and shift is made to S402. At S408, in order to terminate the operation of the camera, the instructions to stop the power supply to the surrounding circuits and the termination setting such as the retraction of data are effected, and the operation is ended.

What has been described above is the operation flow of the system control part, and by the above-described operation, as shown in FIGS. 11A and 11B, even if the position of the camera is changed from that of FIG. 11A to that of FIG 11B, it becomes possible for the operator to operate the camera in the same sense as before the change in the position by changing the information display of some parts and the role of the cross key. Also, the replay image itself is not rotation-converted and therefore, it becomes possible for the replay image to be appreciated from various directions.

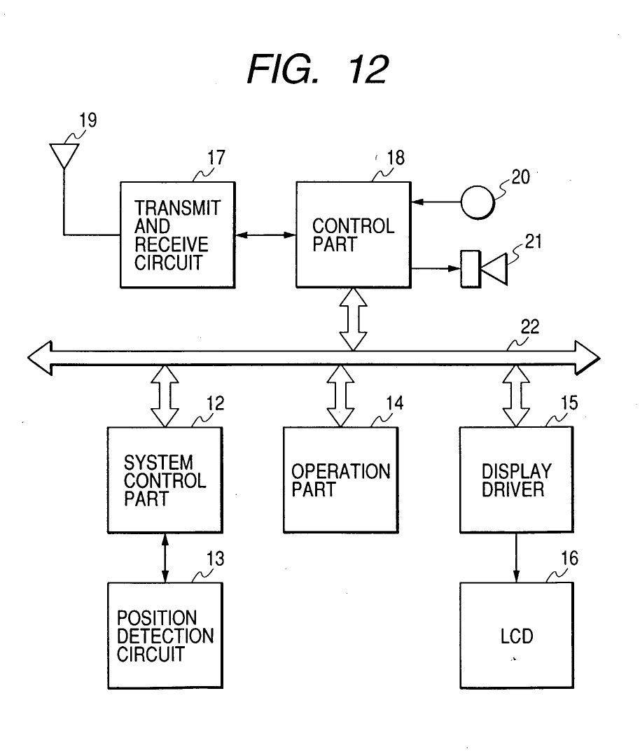

In the above-described embodiment, description has been made of an example in which the cross key is applied to the camera. The application of it to a cellular phone will now be described. An embodiment thereof will hereinafter be described in detail with reference to FIGS. 12 to 18A and 18B. FIG. 12 is a block diagram schematically showing the construction of the present invention.

In FIG. 12, the reference numeral 12 designates a system control part which effects communications with a control part, a position difference detection circuit, a display driver and an operation part and effects the control of an entire system. The reference numeral 13 denotes a position difference detection circuit for detecting the positions (position 0 (antenna is located upward), position 1 (antenna is located leftward), position 2 (antenna is located rightward) and position 3 (antenna is located downward)) of the main body of the telephone.

The reference numeral 14 designates an operation part provided with a power supply switch and operation buttons such as a menu key, a key pad and cross keys. The reference numeral 15 denotes a display driver which drives liquid crystal display 16 in accordance with data sent by communication. The reference numeral 17 designates a transmit and receive circuit comprised of a circuit for receiving reception data from an antenna 19 and a transmit circuit for outputting the reception data from the antenna 19. The reference numeral 18 denotes a control part which includes a modulation and demodulation part and modulates and demodulates the transmission and reception data. The control part 18 has a microphone 20 and a speaker 21 connected thereto, and effects the control of the inputting and outputting of a voice signal.

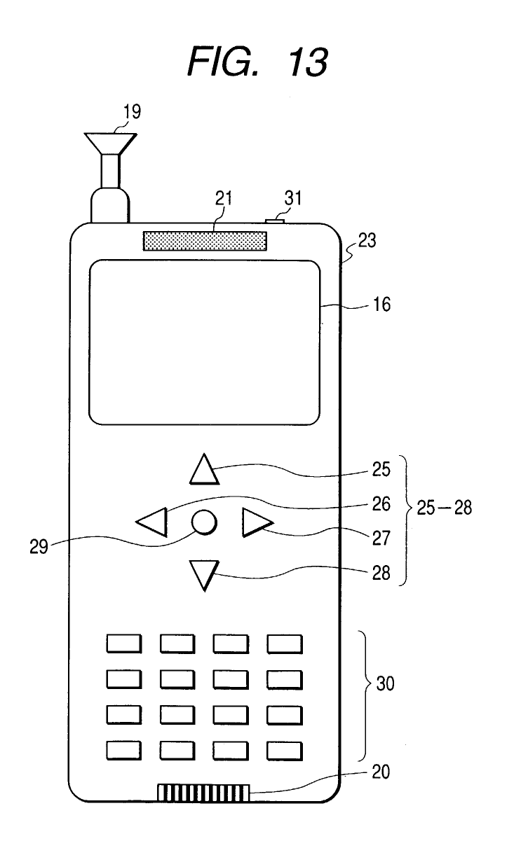

FIG. 13 is a front view of the telephone, and shows the arrangement of the operation buttons and displays used in the description of an operation flow which will be described later. The same members as those in FIG. 12 are given the same reference numerals.

The reference numeral 23 designates the main body of the telephone. The reference numeral 19 denotes an antenna which effects the transmission and reception of data, and the reference numeral 21 designates a speaker which outputs the received voice data. The reference numeral 16 denotes a display as liquid crystal display, which effects such displays as the display of received data, the display of transmitted data, the display of image data, menu display and various setting displays.

The reference numerals 25 to 28 designate cross keys which are used as various setting operation keys such as operation keys for menu selection. The reference numeral 29 denotes a menu key which is a key for shifting to a menu mode. The reference numeral 30 designates a key pad including numeral keys for telephoning. The reference numeral 31 denotes a power supply switch which is a switch for supplying electric power to the system.

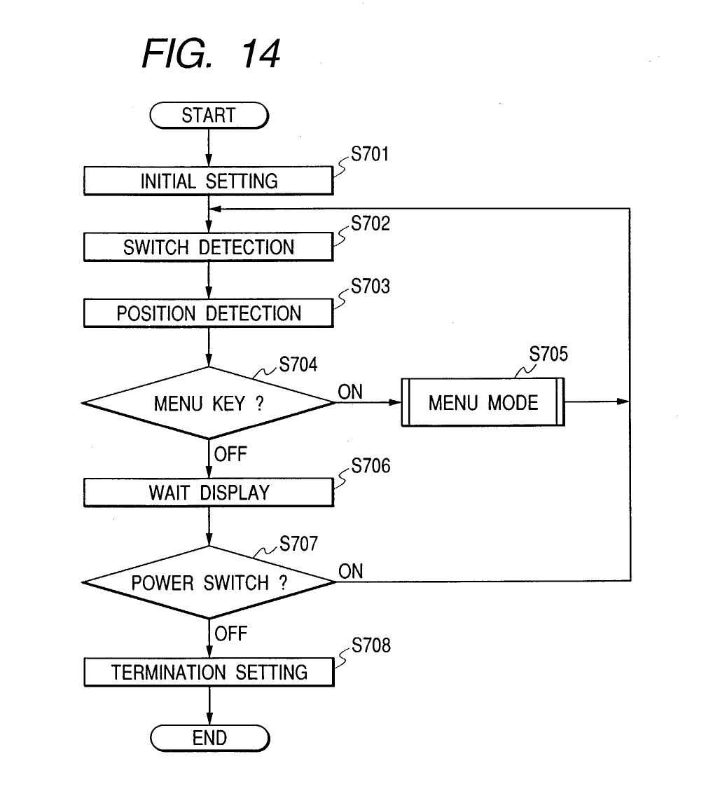

FIGS. 14 to 17 are flow charts representing the operation flow of the telephone, which will hereinafter be described in detail.

At S701 in FIG. 14, the system control part effects initial setting including the initialization of a register and the initialization of the surrounding circuits. At S702, the states of the switches such as the menu key, the cross keys, the key pad and the power supply switch are detected from the operation part by communication. At S703, the position of the telephone is detected by the position difference detection circuit.

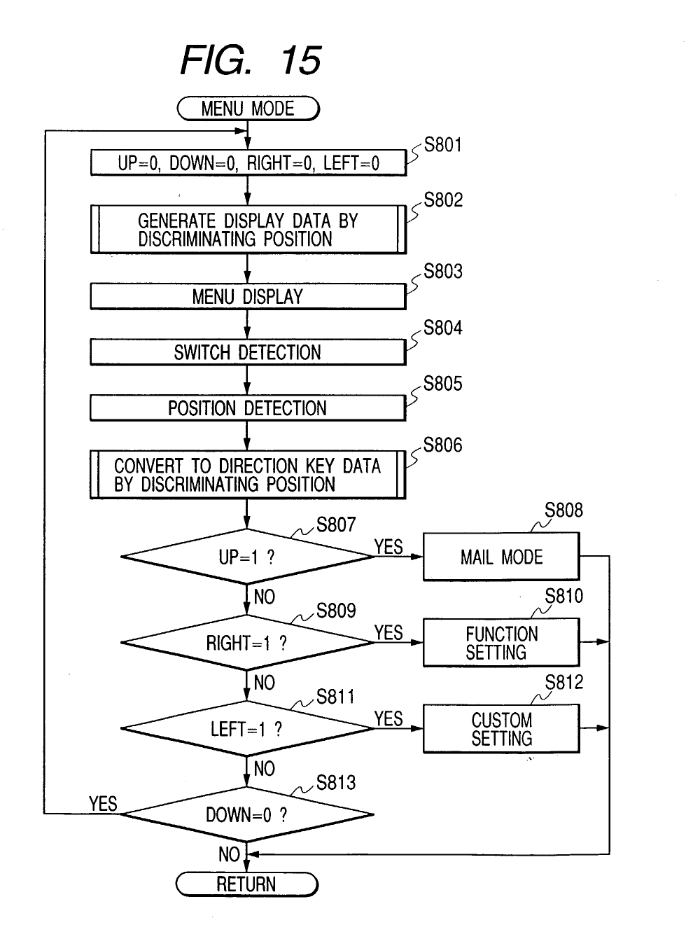

If at S705, the menu key is ON, shift is made to the menu mode at S705, and if not so, shift is made to S706. The operation in the menu mode will be described in detail here with reference to FIG. 15.

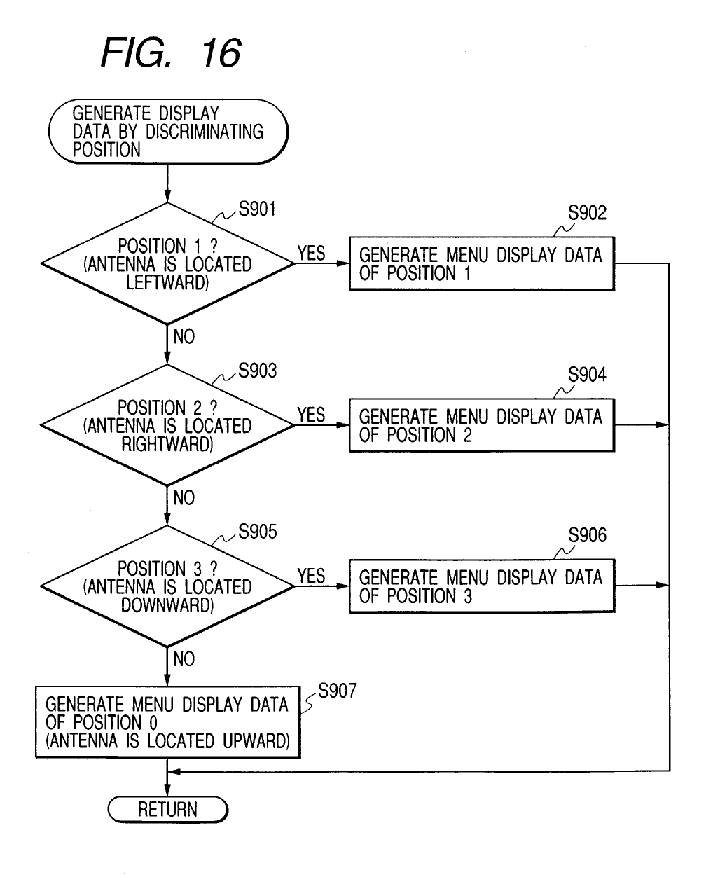

At S801 in FIG. 15, the operated states of the cross key buttons are indicated and flags (UP, DOWN, RIGHT and LEFT) changed in conformity with the position are set to 0. At S802, the position of the telephone is discriminated and menu display to be indicated on the display is generated. The operation of discriminating the position state and generating display data will be described in detail here with reference to FIG. 16.

If at S901 in FIG. 16, from the information obtained by the detection of the position, the position of the telephone is position 1 (antenna is located leftward), shift is made to S902, where the menu display data of position 1 is generated, and return is made. At S902, the display state is converted so that display or characters can be read in the same direction before and after the change in the position.

If at S903, the position of the telephone is position 2 (antenna is located rightward), shift is made to S904, where the menu display data of position 2 is generated, and return is made. If at S905, the position of the telephone is position 3 (antenna is located downward), shift is made to S906, where the menu display data of position 3 is generated, and return is made. At S907, the menu display data in position 0 (antenna is located upward) is generated, and return is made.

Turning back to FIG. 15, at S803 in FIG. 15, the display data (menu display data) generated by S802 is sent to the display driver and is displayed thereby. At S804, the states of the switches such as the menu key, the cross keys, the key pad and the power supply switch are detected from the operation part by communication. Here, the switch states sent by communication are switch off at 0 and switch on at 1. For example, if the state data of the menu key is 1, the menu key is depressed, and if the state data of the menu key is 0, the menu key is not depressed.

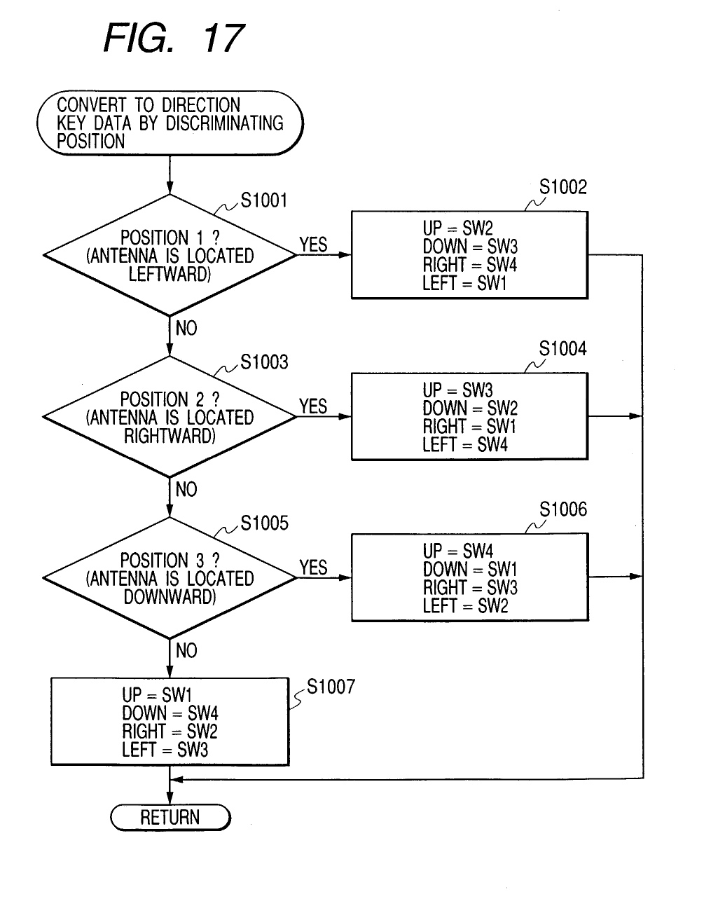

At S805, the position state of the telephone is detected by the position difference detection circuit. At S806, the position information obtained at S805 is discriminated and converted to direction key data. Basically, this is the same work as that in the embodiment shown in FIG. 6, but the converting operation will hereinafter be described with reference to FIG. 17.

If at S1001 in FIG. 17, the position of the telephone is position 1, shift is made to S1002, where SW2 state data is inputted to UP flag, SW3 state data is inputted to DOWN flag, SW4 state data is inputted to RIGHT flag, and SW1 state data is inputted to LEFT flag, and return is made.

If at S1003, the position of the telephone is position 2, shift is made to S1004, where SW3 state data is inputted to UP flag, SW2 state data is inputted to DOWN flag, SW1 state data is inputted to RIGHT flag, and SW4 state data is inputted to LEFT flag, and return is made.

If at S1005, the position of the telephone is position 3, shift is made to S1006, where SW4 state data is inputted to UP flag, SW1 state data is inputted to DOWN flag, SW3 state data is inputted to RIGHT flag, and SW2 state data is inputted to LEFT flag, and return is made.

At S1007, the telephone is levelled in the usual normal position and therefore, as the data of position 0, SW1 state data is inputted to UP flag, SW4 state data is inputted to DOWN flag, SW2 state data is inputted to RIGHT flag, and SW3 state data is inputted to LEFT flag, and return is made.

Turning back to FIG. 15, if at S807 in FIG. 15, UP flag is 1, shift is made to a mail mode for effecting the transmission of the mail of S808, the confirmation of the reception thereof, etc., and if not so, shift is made to S809.

If at S809, RIGHT flag is 1, shift is made to the function setting of S810, and if not so, shift is made to S811. If at S811, LEFT flag is 1, shift is made to the custom setting of S812, and if not so, shift is made to S813.

If at S813, DOWN flag is 1, the menu mode is cancelled and return is made, and if not so, shift is made to S801, where loop is made.

Turning back to FIG. 14, at S706 in FIG. 14, in other operation judging process, a plurality of signal processings are carried out such as carrying out the reception process of telephone numbers by the operation of a telephone starting key, not shown, and carrying out the process of re-telephoning to the telephone number called last time by the operation of a dial key, not shown.

If at S707, the power supply switch remains ON, loop is made to S702, and if not so, at S708, in order to terminate the operation of the system, the terminating processes such as the instructions to stop the power supply to the surrounding circuits and the retraction of the data are carried out, thus terminating the operation.

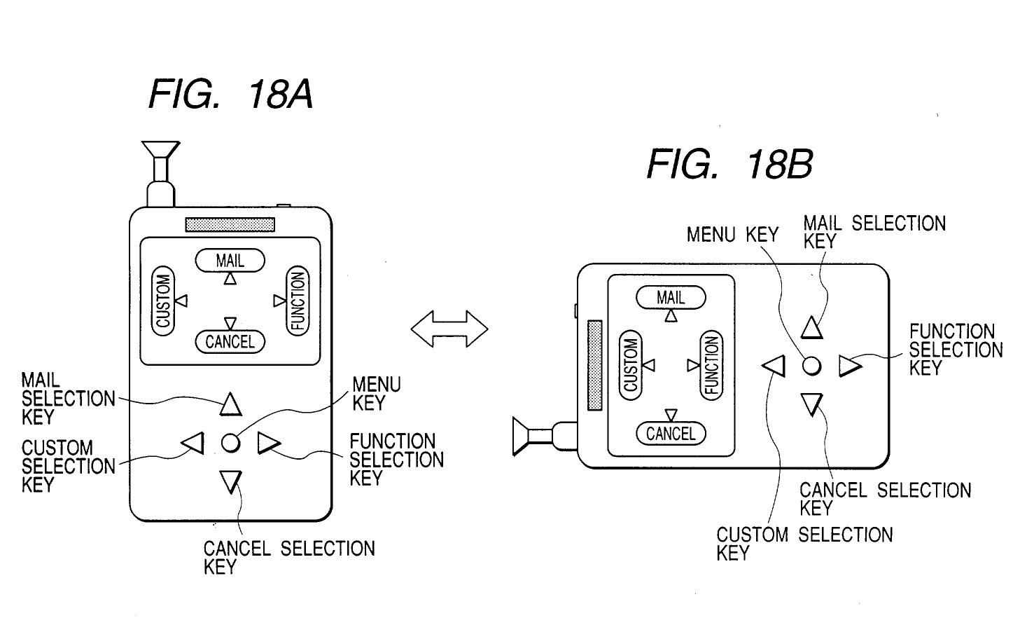

What has been described above is the operation flow, and by the above-described operation, even if as shown in FIGS. 18A and 18B, the position of the telephone is changed, the display by the telephone is changed over depending on the position difference, and the role of the cross keys likewise becomes capable of being changed over depending on the position. Accordingly, it becomes possible to perform the operation with the same operating sense before and after the change in the position.

As described above, according to the present invention, the direction of display is changed in conformity with the position difference of the apparatus (the camera or the telephone) and the operation direction of the cross key is changed in accordance with the change in the direction of display, whereby the display and the operability of the cross key can be made the same so that even if the position of the camera is changed, the operator can easily operate it.

Also, by adopting the construction of claim 7, even if the direction of display and the operation direction of the cross key are changed in conformity with the position of the apparatus, the replay image is not changed and therefore, the replay image can be appreciated from any position.

What is claimed is:

1. An information display apparatus comprising:
a display member for displaying information;
operating means having operation parts disposed at at least four upper, lower, left and right locations;
a control circuit for effecting predetermined control by said operation parts being operated;
a position detecting part for detecting the position state of the apparatus;
display changing means for changing the direction of the predetermined display displayed on said display member, in conformity with the result of the detection by said position detecting part; and
operation part changing means for changing the operated location of said operation parts which effect said predetermined control, in conformity with the result of the detection by said position detecting part.

2. An apparatus according to claim 1, wherein said predetermined display is a plurality of displays constituted by a row of characters indicative of the control mode of said apparatus, and said display changing means changes the direction of arrangement of said row of characters and the position of said row of characters in conformity with the position.

3. An apparatus according to claim 2, wherein said predetermined control is the control of effecting display indicative of selected one of a plurality of displayed control modes.

4. An apparatus according to claim 1, wherein said predetermined display is a display indicative of the substance of the operation of said operation parts, and said display changing means changes the display direction and position of the substance of said operation.

5. An apparatus according to claim 4, wherein said predetermined control is control conforming to the substance of said operation.

6. An apparatus according to claim 1, wherein said display member displays a photographed image, but said image has its direction not converted by the position.

7. An information display apparatus comprising:
a display member for displaying information;
operating means having operation parts disposed at at least four upper, lower, left and right locations;
control means for effecting predetermined control by said operation parts being operated;
position detecting means for detecting the position state of the apparatus;
display changing means for rotating the display displayed on said display member and also changing the position of the display, in conformity with the result of the detection by said position detecting means; and
operation part changing means for changing the operated location of said operation parts which effect said control in conformity with the result of the detection by said position detecting means.
